(19) United States
(12) Patent Application Publication
(10) Pub. No.: US 2026/0042392 A1
(43) Pub. Date: Feb. 12, 2026

(54) Hand Carry Item(s) Reminder for Vehicle Passenger

(71) Applicant: KWOK FAI JIM, Hong Kong (CN)

(72) Inventor: KWOK FAI JIM, Hong Kong (CN)

(21) Appl. No.: 19/270,420

(22) Filed: Jul. 15, 2025

Related U.S. Application Data
(63) Continuation of application No. PCT/CN2024/110959, filed on Aug. 9, 2024.

(51) Int. Cl. B60Q 9/00; G08B 21/24

(52) U.S. Cl. CPC B60Q 9/00; G08B 21/24

(57) ABSTRACT

The present invention discloses a hand carry item(s) reminder for vehicle passenger which comprises a reminder body; the reminder body is connected with a first switch assembly and a second switch assembly; the first switch assembly is triggered by a passenger, and the second switch assembly is triggered when a vehicle door is located at an opening position. The first switch assembly and the second switch assembly are cooperatively triggered to enable the reminder body to send a hand carry item(s) reminder to a passenger. The reminder is a prompt ringing device arranged on a vehicle, and aims to remind a passenger to check and carry all things before leaving the vehicle, so that the loss caused by the lost things in the vehicle is avoided, or the trouble caused by returning to a parking place to take away the things which should be carried are avoided.

### CROSS REFERENCE TO APPLICATIONS GRANTED

The present application is an improved design of the application granted in China of Invention Patent No. ZL 201310309264.0 and application granted in the U.S. Pat. No. 9,430,932 B2 as well as application granted in India of Patent No. 420808.

### FIELD OF THE INVENTION

The present invention relates to a hand carry item(s) reminder for vehicle passenger, and more particularly to a reminder device for reminding the passenger on a vehicle to take out personal item(s) or belongings while leaving the vehicle.

### DESCRIPTION OF RELATED ART

Taxi is an essential traffic means in daily life. Many taxi passengers leave their belongings inadvertently in the taxi. In Hong Kong, there is a telephone hot line for those passengers to report their lost belongings in the taxi and see if they can get their things back, but the chance for claiming those lost items will depend on the moral integrity of the taxi driver and/or the next passenger thereof. Most of those lost items will be taken away by the next passenger of the taxi. According to news report, there are about 10,000 and 1,000 reported cases per month in London for leaving mobile phones and portable computers respectively in taxis. The report did not mention the number of the loss of other items. Similar situations are expected to be found to exist in other cities. Further, private car users sometimes might forget to take out things as they should when leaving their cars, and thus it is inconvenient and waste of time to go back to the car park to take out those things. As there is too much uncertainty to rely on one's honesty or memory to avoid the risk of lost property and people are often negligent, it is necessary to adopt scientific methods to avoid such situations, so it is desirable to remedy such troubles and losses caused by the intrinsic defects of human brain with a specific device.

### BRIEF SUMMARY OF THE INVENTION

In order to solve at least partially the above problem, the present invention provides a hand carry item(s) reminder for use in an automobile comprising a main-body operationally connected with a first and a second reed switch boxes, a permanent magnet set and a strong permanent magnet; and the main-body further comprises a main switch assemblage operationally connected with a battery box, a sound generator box and a sound stopping button assemblage which is a permanent magnet push-to-break switch for switching off the sound generator box but not switching off the reminder; the main-body can be mounted anywhere on the door convenient for use inside a car, and the permanent magnet set is mounted on the back side of a door opening handle inside the car cabin and cooperated with the first reed switch box arranged below the door opening handle such that a reminding sound is generated via switching on the sound generator box when the door opening handle is pulled for opening the door from inside the car, and the strong permanent magnet is arranged along the edge of a door frame or on the cabin floor of the car and cooperating with the second reed switch box arranged on the door inside the car cabin near the strong permanent magnet or on the bottom edge of the back of the main-body when mounted near the car floor such that the reminding sound is stopped when the door is closed.

According to the first selected embodiment of the present invention, the permanent magnet set comprises a strong permanent magnet and a permanent magnet carrier with a scale line from top to bottom on the middle part of its slanting side; the first reed switch box is a permanent magnet reed switch box which is a reed switch box comprising a box body, a reed switch and a small strong permanent magnet held in a compartment on one side of the box body; the small, strong permanent magnet keeps the reed switch switched on normally; there is a scale line marked 1 mm from either box end; the scale line by the small, strong permanent magnet of the box is for visual indication guide of mounting the permanent magnet reed switch box with its scale line by the small, strong permanent magnet within 10 mm right under the scale line of the above locus of the permanent magnet set when the door handle inside the car cabin is pulled for opening the door, sideward deviation within 3 mm is valid; the best position of fixing the strong permanent magnet on the car cabin floor or the car door frame is to make its center within the closest perpendicular distance of 10 mm from the middle part of one of the scale line of the second reed switch box near the car door edge, deviation within 3 mm is valid; a permanent magnet protector is available to ring the strong permanent magnet if it is not embedded in the car cabin floor or the car door frame.

The above is the wires-linked part(s) description of this invention and is also that of the present invention market product with the circuitry shown in FIG. 45.

The main construction of this invention is the main-body which comprises the battery box, the main switch assemblage, the sound generator box and the sound stopping button assemblage which is a permanent magnet push-to-break switch; there is a safety shield to cover the main-body for protecting it and the passenger and also for good-looking purpose.

There is a triangle sign between the right hand side screw fixing hole of the main-body and the sound generation box frame. For closing the battery box screw-cap, it is necessary to place the “lock opened” sign on the battery box screw-cap right over the triangle sign and push down the box screw-cap, then screw the screw-cap clockwise until the other sign on the screw-cap changes position to right over the triangle sign. This design is completely for easy manufacture of the market product. It is watertight. Opening the screw-cap just requires to screw the screw-cap counterclockwise.

The battery box comprises a battery compartment and a watertight circuit board shelter holding the circuit board installed from the big recess at the back of the main-body; that recess forms that platform; two wires are solder-connected to the battery compartment and made pass through a hole at the battery box base to connect to the circuit board set which also has wires connecting the first reed switch box (permanent magnet reed switch box) for mounting under the door opening handle inside the car cabin, the second reed switch box for mounting near the door edge or the bottom edge at the back of the main-body, the third reed switch box in the sound stopping button assemblage (permanent magnet push-to-break switch), the fourth reed switch box in the main switch assemblage and the loudspeaker of the sound generator box; the internal top part of the battery box screw-cap can prevent the displacement of the battery arranged in the battery compartment.

The sound stopping button assemblage is a platform on the upper part of the main-body; it has a square opening with two pairs of different arc corners for matching the surface of the sound stopping button which can be pressed to stop the reminding sound when wanted; the sound stopping button has a permanent magnet (small, strong permanent magnet) embedded in one side; there is a third reed switch box embedded partly in the platform; at the bottom centre of the sound stopping button is a small jut for holding a spring which can return the sound stopping button to its top position after being fully depressed due to the support of a barrier support plate which is fixed to the main-body back by four clips about the four corners respectively; the barrier can also prevent the finger or other objects from pushing the spring off; it is also a ventilative design for letting the entered water vaporize easily; the accumulated dust inside can be flushed away by water jet; when the sound stopping button is fully pressed, the third reed switch box will leave the magnetic force position switched on by the small, strong permanent magnet inside the sound stopping button, thus switching off to stop the reminding sound; it needs no another button pressing to restore the reminding function because the reminder will not be switched off by pressing the button.

The main switch assemblage comprises a main switch base plate fitted with a fourth reed switch box, a main switch cover, a push switch embedded by a small, strong permanent magnet at its bottom surface; the main switch cover has a slot track to provide a sliding displacement for the push switch; there is a spring wire with outward curves for temporary holding the inward curved brim of the push switch in the ON/OFF position.

The sound generator box comprises a loudspeaker, a sound generator box frame and the box's screw-cap; there is a hole inside the box frame base to let the loudspeaker's solder connected wires to pass through to connect to the circuit board at the main-body back; the loudspeaker rim touches the internal wall of the box frame; waterproof adhesive is applied to seal them along the circumference; the hole gap where the loudspeaker wires pass through is also sealed with waterproof adhesive; this prevents water from entering the back space of the loudspeaker; the front part of the loudspeaker is waterproof; there are numerous pores through the box screw-cap for good sound transmission; the box's screw-cap can be opened for sweeping clean the accumulated dust. The method of opening and closing of the sound generator box screw-cap is similar to that of the battery box screw-cap.

There is a safety shield to cover the main-body for protecting it and the passenger and also for good-looking purpose; the safety shield has a common coin-sized, shallow recess above the sound stopping button area; the middle part of the recess has a hole with its perimeter fitting that of the sound stopping button which can be moved smoothly up and down; when the safety shield covers correctly on the main-body, the top of the sound stopping button levels the top surface of the safety shield; the corner parts of the safety shield have downward stretches carrying individual grippers to hold the bottom side of the main-body temporarily; holding to pull the lower side of the safety shield's either shorter side can open the safety shield; the four small rectangular holes on the safety shield are necessary when moulding the grippers; they can be sealed up by other assembling parts; the safety shield has enough pores for good sound transmission.

In the case of a taxi with button switches for the taxi driver to open and close the car door, a device installation provided from this invention can be operationally connected to the taximeter, the door opening switch and the door closing switch. It can apply the reed switch boxes for switching, so it will not ignite any surrounding inflammable gas.

Referring to the circuitry in FIG. 48 or FIG. 49 provided from this invention, the circuit of that installation is switched on by the switch 201 as the taximeter starts; the circuitry in FIG. 49 is more stable and durable than that of FIG. 48.

The circuit is switched ON as the driver starts the taximeter; when the taxi arrives the destination, the passenger pays the fare and the driver switches to open the car door; as that switch is connected to the push-to-make switch 202 and the circuit is still switched on though the taximeter stops running, so the reminder call is activated by the switching open of the car door; after the passenger's getting off, the driver switches to close the door and switches simultaneously a push-to-break switch 203 which stops the call; the taximeter is then returned to the unhired position and the circuit is switched off; maybe few drivers return the taximeter to the unhired position after receiving the passenger's fare, and then switch open the car door; repeated instruction can change that.

Summing up the above, the present invention provides a hand carry item(s) reminder for use in an automobile and being low in cost and in conformity with safety requirements for driving, which could remind the passenger on a vehicle to check and take out personal items or belongings that should not be left behind while leaving the vehicle. The present invention is highly applicable and relatively low in cost, while it is waterproof and will not ignite an explosion of any inflammable gas that probably exists in its surroundings.

### BRIEF DESCRIPTION OF THE DRAWINGS

FIG. 1 is a lateral view showing the hand carry item(s) reminder of the present invention mounted on the door inside an automobile, wherein the main-body of the hand carry item(s) reminder mounted on the front door is provided with a safety shield.

FIG. 2 is a lateral view showing a preferable mounting position for the main-body when there is a car seat's shelter.

FIG. 3 is an exploded view showing the permanent magnet set to be mounted on the back of the door opening handle, also the permanent magnet reed switch box and its safety cover to be mounted below the door opening handle.

FIG. 4 is a schematic view after assembling the parts in FIG. 3.

FIG. 5 is an exploded view and back view of the permanent magnet set.

FIG. 6 is a schematic view of the permanent magnet set.

FIG. 7 is an exploded view of the permanent magnet reed switch box and a small, strong permanent magnet to be assembled in a compartment at one side of it.

FIG. 8 is a schematic view showing the assembled permanent magnet reed switch box.

FIG. 9 is a schematic view of the reed switch and the small, strong permanent magnet of the permanent magnet reed switch box and its adjacent strong permanent magnet without drawing the reed switch box shell/body.

FIG. 10 is an exploded view of the reed switch box.

FIG. 11 shows the dimensions of the reed switch box.

FIG. 12 is an exploded view of the permanent magnetic rod box.

FIG. 13 shows the dimensions of the permanent magnetic rod box.

FIG. 14 illustrates that the connection wires of the reed switch box can come out from one end rather than the middle part thereof.

FIG. 15 is an exploded view of the main-body.

FIG. 16 is a schematic view showing the assembled main-body.

FIG. 17 is a sectional view showing the screw-fixing hole.

FIG. 18 is an exploded view of the sound stopping button assemblage (permanent magnet push-to-break switch).

FIG. 19 illustrates the assembled sound stopping button assemblage.

FIG. 20 is a sectional view of the sound stopping button assemblage without drawing the barrier of the barrier support plate.

FIG. 21 is an exploded view showing the insertion of the small, strong permanent magnet into the sound stopping button.

FIG. 22 is a schematic view of the assembled sound stopping button.

FIG. 23 is an exploded view of the main switch assemblage.

FIG. 24 illustrates the assembled main switch assemblage.

FIG. 25 illustrates the ON and OFF positions of the push switch of the main switch assemblage.

FIG. 26 is an exploded view of the inverted push switch.

FIG. 27 illustrates the assembled, inverted push switch.

FIG. 28 illustrates the installation of the reed switch box, the permanent magnetic rod box and the safety cover for the reed switch box.

FIG. 29 is a schematic view of the door opening handle after assembling the parts shown in FIG. 28; the magnetic rod box can also have a safety cover.

FIG. 30 illustrates the door opening handle inside the car cabin.

FIG. 31 illustrates that the strong permanent magnet can be fixed inside the door opening handle during the car's manufacture.

FIG. 32 is a sectional view of the push-to-break switch inside a cylindrical container with a screw-cap.

FIG. 33 is a sectional view of the push-to-make switch inside a cylindrical container with a screw-cap.

FIG. 34 illustrates a styrofoam piece provided for mounting the main-body on the car door at a fixed distance of 9-10 mm above the car cabin floor.

FIG. 35 is a partial sectional front view and side view of the main-body mounted on the car door at a position closed to the car cabin floor; it shows the best position of the reed switch box to be influenced by the magnetic field of the strong permanent magnet which is valid to deviate within 3 mm.

FIG. 36 is a partial sectional front view and side view of the main-body mounted on the car door at a position closed to car cabin floor; it shows the best position of the permanent magnet reed switch box to be influenced by the magnetic field of the strong permanent magnet with the correct pole facing upwards; deviation within 3 mm is valid.

FIG. 37 is an exploded view of the permanent magnet to be mounted with its protector.

FIG. 38 illustrates the permanent magnet with its protector.

FIG. 39 is an exploded view of the main-body to be covered by its safety shield.

FIG. 40 is a schematic view showing the main-body covered by its safety shield.

FIG. 41 illustrates the steps of mounting the permanent magnet set on the back of the door opening handle and mounting the permanent magnet reed switch box below the door opening handle.

FIG. 42 illustrates the steps of mounting the strong permanent magnet at the car cabin floor after mounting the main-body on the car door close to the cabin floor.

FIG. 43 is an exploded view of the wires-reel to be covered by the wires-reel cover.

FIG. 44 illustrates the wires-reel cover with the wires-reel inside.

FIG. 45 illustrates the circuitry of the first embodiment of the present invention (market product circuitry).

FIG. 46 illustrates the circuitry of the second embodiment of the present invention.

FIG. 47 illustrates the circuitry of the third embodiment of the present invention.

FIG. 48 illustrates the circuitry of the fourth embodiment of the present invention (for taxi driver's control).

FIG. 49 illustrates the alternative circuitry of the fourth embodiment of the present invention (a more stable and durable one).

FIG. 50 is an exploded view of the bottom part of the main-body.

FIG. 51 is a schematic view showing the embedded watertight circuit board set and the arrangement of the connection cables at the bottom part of the main-body.

### LIST OF REFERENCE SIGNS IN THE DRAWINGS

1: main-body, 2: reed switch box or permanent magnet reed switch box with safety cover, 3: permanent magnetic rod box, 5: main switch assemblage, 6: styrofoam piece, 8: wires-reel cover with reel, 10: main-body safety shield, 11: battery box, 12: sound generator box, 16: sound stopping button assemblage,
20: safety cover for reed switch box/permanent magnet reed switch box/permanent magnetic rod box, 21: reed switch box, 22: permanent magnet reed switch box, 31: permanent magnetic rod box shell/body, 32: permanent magnetic rod,
33: permanent magnet set, 36: car cabin floor, 37: car seat, 38: door opening handle, 39: car door, 51: main switch base plate, 52: main switch cover, 53: push switch, 531: push switch body, 81: wires-reel, 82: wires-reel cover, 100: main-body with safety shield, 111: battery compartment, 112: recess for holding circuit board set, 112A: circuit board set, 112B: watertight circuit board shelter, 113: battery box base, 114: battery box screw-cap, 121: loudspeaker, 122: sound generator box frame, 123: sound generator box screw-cap, 161: sound stopping button, 162: small, strong permanent magnet, 163: spring, 164: barrier support plate, 201: electric switch switched on as the taxi driver starts the taximeter, 202: push-to-make switch triggered by taxi driver's button-pressing to open the door, 203: push-to-break switch triggered by taxi driver's button-pressing to close the door, 211: reed switch box body, 212: reed switch, 221: reed switch box with a compartment at one side of it to hold a small, strong permanent magnet, 331: permanent magnet carrier, 332: 5 mm diameter strong permanent magnet, 333: 6/6.3 mm diameter strong permanent magnet, 334: permanent magnet protector, 335: permanent magnet with its protector, 336: pillars for locating permanent magnet, 337: card for locating permanent magnet, 338: plate for locating permanent magnet, 339: adhesive tape, 1121-1126: cables extended from watertight circuit board shelter, 2021: cylindrical container, 2022: body of cylindrical container, 2023: screw-cap, 2024: shaft, 2025: center bearing tube, 2026: push button, 2027: ring, 2031: cylindrical container, 2032: body of cylindrical container, 2033: screw cap, 2034: shaft, 2035: center bearing tube, 2036: push button, 2037: ring.

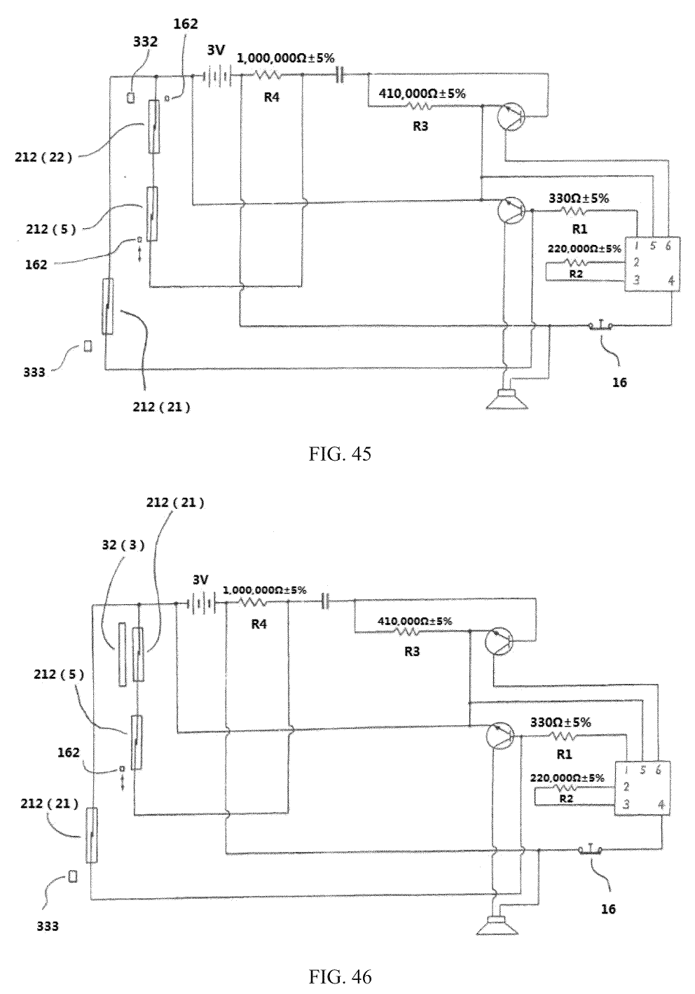

In FIG. 45-FIG. 47, the bracketed number following the reference sign of a component represents the reference sign of the assemblage to which the component belongs, e.g. 212(5) means the reed switch 212 is a component of the main switch assemblage 5.

### DETAILED DESCRIPTION OF EMBODIMENTS OF THE INVENTION

The details of the present invention will be described hereunder to enable a better understanding of the embodiments thereof. However, it will be understood by those skilled in the art that the embodiments may be carried out without one or more specific details or they could work with other devices, systems, assemblies, processes, materials, components, or the like, while the well-known configurations, materials, or operations will not be specifically shown or described in detail so as not to obscure the embodiments of the present invention.

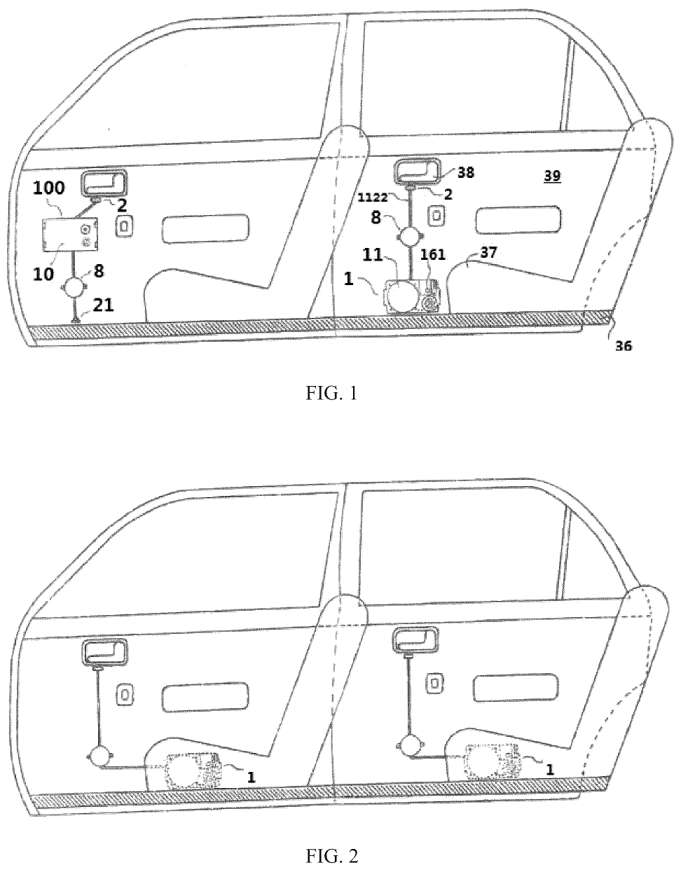

As shown in FIG. 1, the present invention can be installed separately on each door of an automobile or car, or this invention can be embedded or concealed in respective doors while assembling the car, then only two switches will be exposed and the installation cost will be reduced significantly; one switch is used for stopping the reminding sound but not switching off the reminder and the other sideward push switch is used for switching off the reminder.

The chief function is that a signal or reminding sound will be activated only when the door is opened from inside the automobile, and the reminding sound will be stopped automatically when the door is closed.

The first supplementary function is that the reminding sound can be stopped at once by merely pressing one button, and it requires no another button pressing to restore the call function because the reminder will not be switched off by pressing the button.

The second supplementary function is that when the door opener from inside the car's cabin wants to avoid the call for that time, that button should be pressed with one finger and held with the cooperation of another one or two fingers until the door's opening displacement made by the other hand is at least 2 to 3 cm and the door-opening handle returned to its original position.

The preferred embodiments of the present invention will be described in details below with reference to the accompanying drawings, wherein two basic circuitries are respectively employed.

### FIRST EMBODIMENT

The present embodiment employs a reed switch or magnetic switch type door opening reminder circuit (FIG. 45).

As shown in FIG. 1, the main-body 1 mounted on the front door inside a car is provided with a safety shield 10, a permanent magnet set 33 (mounted on the back of the door opening handle 38), a permanent magnet reed switch box 22 with a safety cover 20 (2), a reed switch box 21 mounted on the car door near the cabin floor, a strong permanent magnet 333 (not shown) of diameter 6.3 mm and thickness 3 mm fixed at the cabin floor nearby one end of the reed switch box and a wires-reel cover with wires-reel 8. The main-body mounted on the back door is shown without the safety shield for easy labelling of various component parts thereof; the reed switch box 21 can also preferably be fixed on the back bottom edge of the main-body to cooperate with the strong permanent magnet 333 fixed at the cabin floor and act as a magnetic switching source.

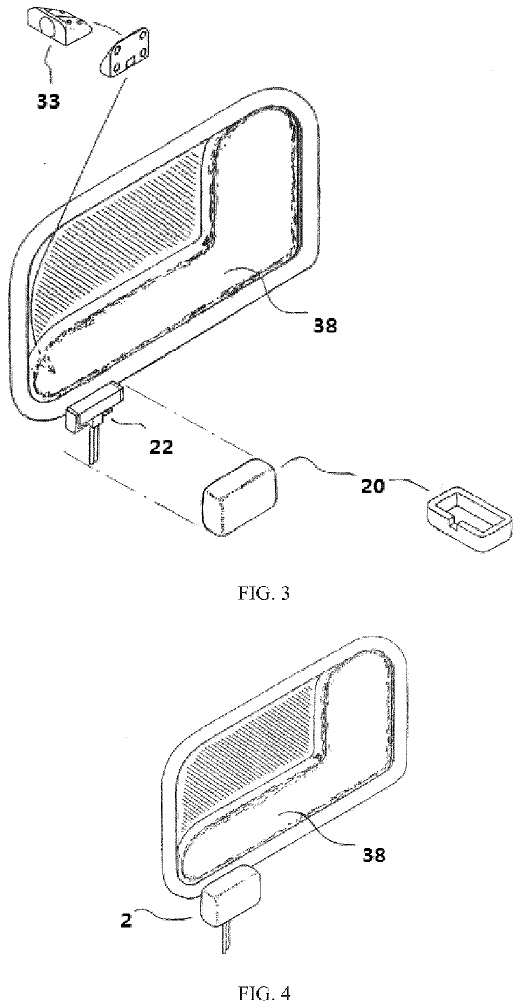

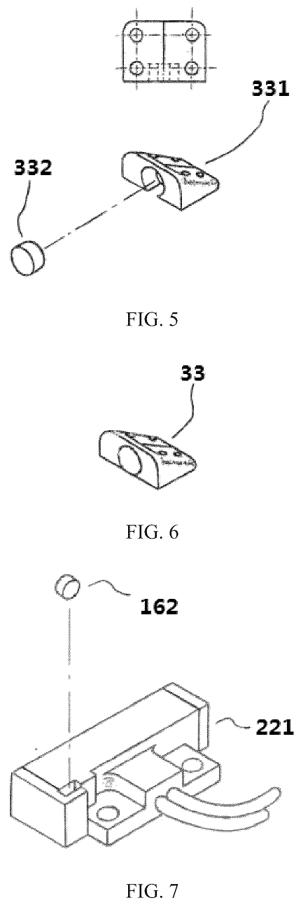

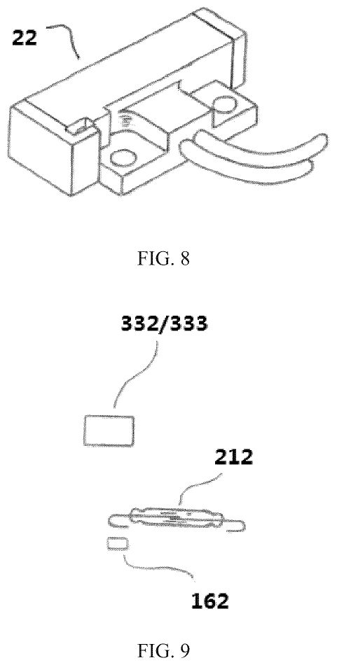

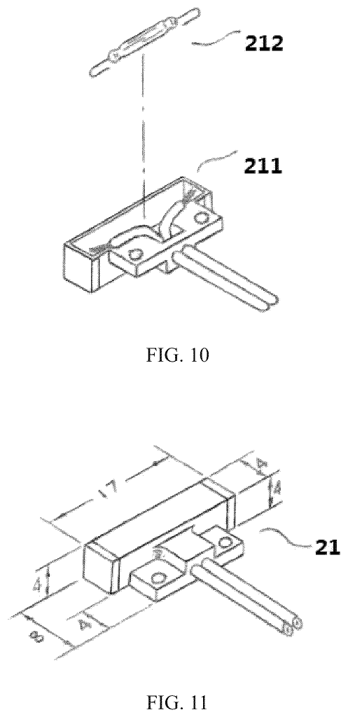

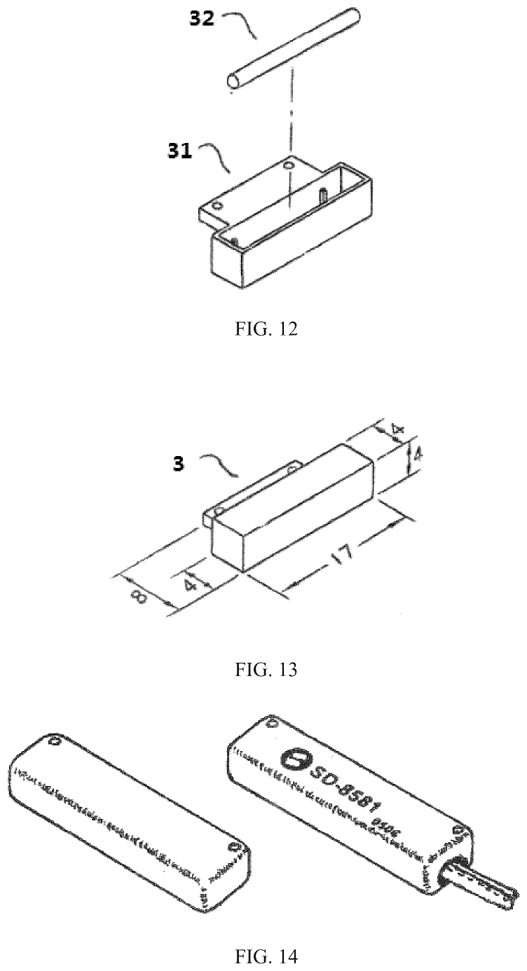

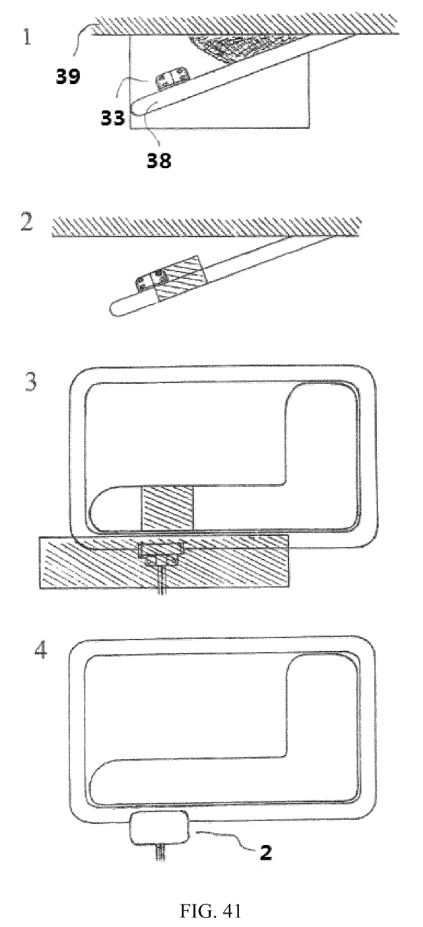

The permanent magnet set 33 (FIGS. 3 & 6) is mounted on the back of the door opening handle, preferably at a distance of about 10 mm from the end of the handle; it comprises a permanent magnet carrier 331 and a strong permanent magnet 332 of diameter 5 mm and thickness 3 mm. The slanting side of the permanent magnet set has a scale line on the middle part from top to bottom for providing visual indication guide of mounting the permanent magnet reed switch box 22 having its scale line by the small, strong permanent magnet within 10 mm right under the locus of the scale line of the permanent magnet set 33 (FIG. 41); deviation within 3 mm sidewards is valid. The reed switch box might adopt the magnet sensor of model no. SD-8571 (FIGS. 11 & 13) or SD-8581 (FIG. 14) from Shenzhen Sunwave Electronic Co. Ltd. Magnetic sensors from other vendors might also be used provided that they could be fitted for mounting on the door opening handle. The reed switch box 21 is provided with two scale lines, each of which is located about 1 mm from respective end of the reed switch box to indicate its best magnetic switching position by magnet. The permanent magnet reed switch box 22 (FIG. 8) comprises a reed switch 212 (FIG. 10), a reed switch box body 221 with a compartment at one side of it (FIG. 8) to hold a small, strong permanent magnet 162 fixed by instant adhesive and close to one of the scale line making the reed switch inside normally connected by a magnetic pole just opposite to that of the permanent magnet set 33 facing downwards. The reed switch 212 (FIG. 10) in the reed switch box 21 and the permanent magnetic rod 32 in the permanent magnetic rod box 3 (FIG. 13) are both fixed by a synthetic adhesive filled therein, and their dimensions are illustrated in the figures.

When the door opening handle from inside the car cabin is pulled for opening the door, the reed switch of the permanent magnet reed switch box will be flash switched off twice owing to the forth and back movement of the permanent magnet set 33 above, because the effective, opposite magnetic field of the north or south pole of the strong permanent magnet 332 will sweep the scale line of the permanent magnet reed switch box located thereunder twice during the process. In fact, the first switching off of the permanent magnet reed switch box can already activate a reminding sound which is released when the car door is opened to more than 2 or 3 cm making the second reed switch box get rid of the magnetic force of the strong permanent magnet 333 on the car cabin floor/door frame. At the moment the permanent magnet set 33 is right on top of the scale line close to the small, strong permanent magnet 162 of the first reed switch box, the effective magnetic field of the strong permanent magnet 332 neutralizes the magnetic force of the opposite magnetic pole of the small, strong permanent magnet facing the wire end of the reed switch making it disconnect inside. The permanent magnet set can also be mounted on other kinds of car door opening handle based on the same principle. Also, the strong permanent magnet can be extracted and mounted on other kinds of car door opening handle in an adhesive manner and such door opening handle can be attracted by magnet or ferromagnetic but not affecting the reminder's functions.

Preferably, the main-body is mounted in a position of the car door sheltered by faced to the lower lateral side of the car seat as shown in FIG. 2 so that the passenger in a sideward collision accident will not be harmed by the main-body. Alternatively, the main-body can be mounted in other positions of the car door inside the car cabin. The safety shield has round sides and corners. The thickness of the safety shield with the main-body is less than 21 mm. It is rather safe to mount this device on a car door inside the car cabin. The main-body can be mounted on the door through four screw-fixing holes of it. If the mounting surface of the door is not flat, provided cushion rings or suitable card piece(s) with centre hole are available to cushion under the appropriate screw-fixing hole(s) of the main-body.

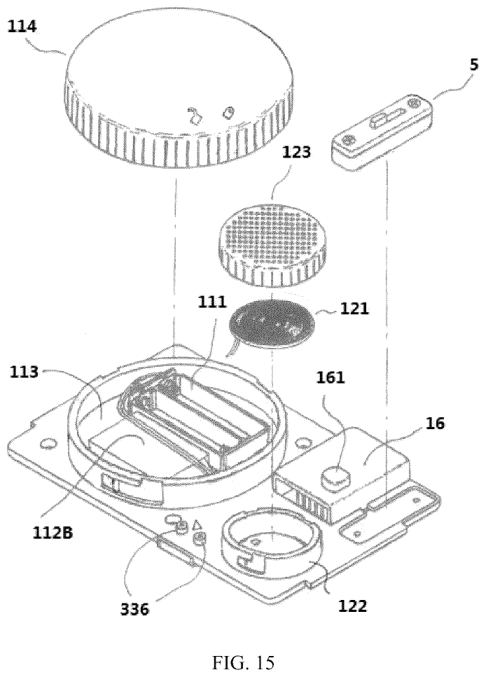

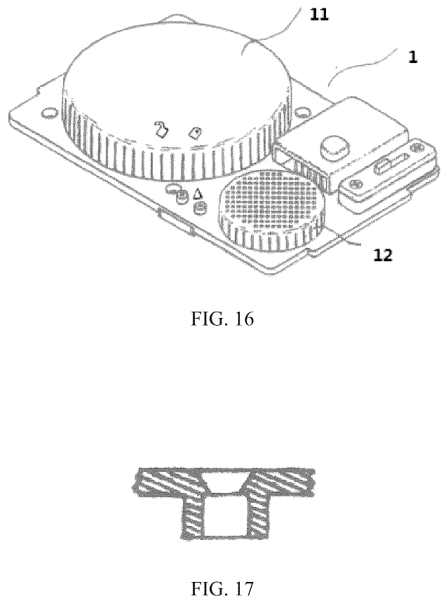

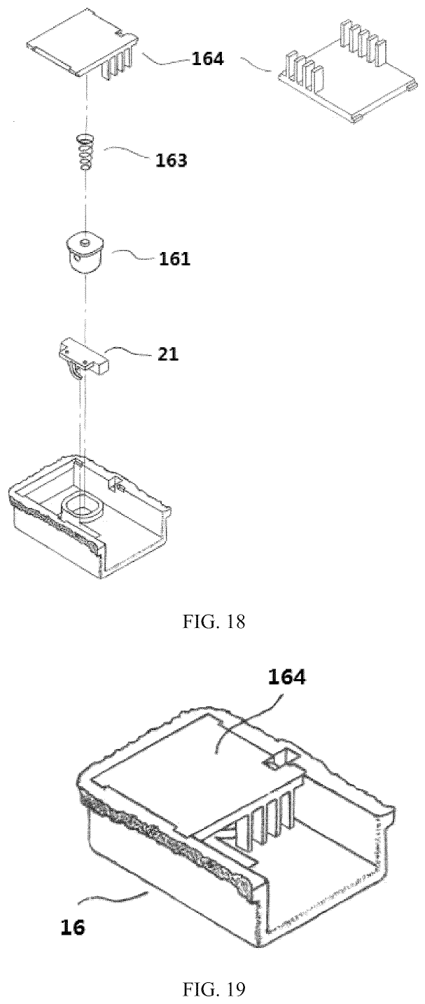

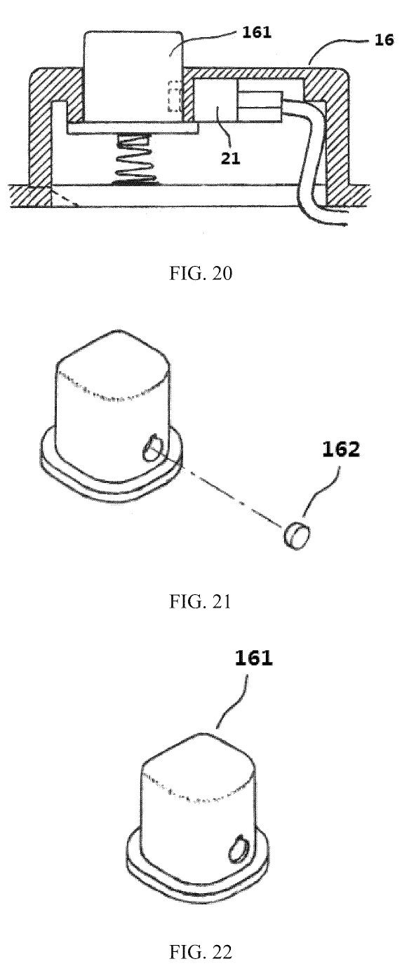

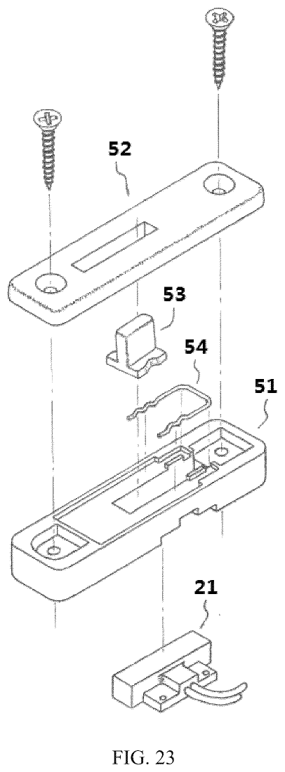

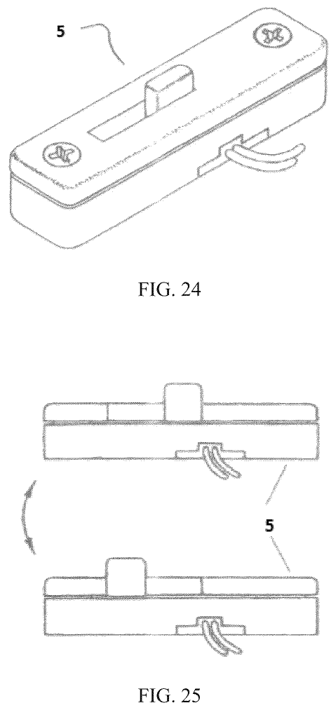

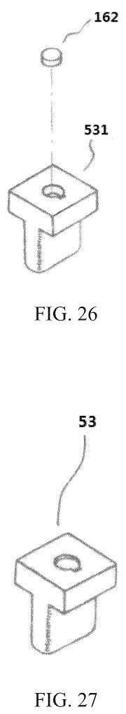

As shown in FIGS. 15 & 16, the battery box 11 comprises the screw-cap 114, the battery compartment 111 and the watertight circuit board shelter 112B. The internal top part of the battery box screw-cap 114 can prevent the displacement of the battery cells.

The circuit board set 112A in the big recess 112 at the main-body back is solder-connected with the battery compartment 111 by two wires 1126 which passes through a hole in the battery box base 113. The circuit board set is also two-wired 1121 connected to the reed switch box of the main switch assemblage 5, 1122 connected to the permanent magnet reed switch box 22 mounted below the door opening handle, 1123 connected to the reed switch box 21 mounted on the door near the door edge, 1124 connected to the loudspeaker 121 of the sound generator box 12, 1125 connected to the reed switch box of the sound stopping button assemblage (permanent magnet push-to-break switch) 16. The circuit board set is then pushed into the big recess 112. The gaps between the wires and the big recess are completely sealed by a leakproof adhesive forming the watertight circuit board set 112A.

The main switch connection position in the circuit can be varied because it is merely a switch for switching off the circuit.

The main switch assemblage 5 (FIG. 24) comprises the main switch base plate 51, the reed switch box 21, the main switch cover 52, the push switch 53 and a spring wire with outward curves for match holding the inward curve brim of the push switch temporarily in either the ON/OFF position (FIG. 23). The push switch body 531 has a recess in the bottom middle part for embedding the small, strong permanent magnet 162 which is fixed by instant adhesive. There is a slot track in the main switch cover 52 to form the track for the push switch. When the push switch is pushed to about the middle of the main switch cover 52 and held by the spring wire temporarily, the small, strong permanent magnet 162 will switch on the reed switch box 21, namely, switch on the reminder. If the push switch is pushed to the other side of the track (FIG. 25), the reed switch box or the reminder will be switched off due to the absence of magnetic force of the small, strong permanent magnet 162.

There are two connection parts in this circuit capable of concealing the reminding call when they are cable connected, recovering their disconnection can resume the call at once; in fact, the activated signal during the cable connection continues inside the circuit without pause until the end of the call. Constant connection of the two connection parts does not consume power. The two wires 1123 are connected separately to the two connection parts and then connected to the reed switch box 21 mounted near the car door edge for switching by the strong permanent magnet 333 which is to be mounted on the car cabin floor or door frame having its center within 10 mm at the closest perpendicular distance from the middle of either the scale line of the reed switch box 21, deviation within 3 mm is valid.

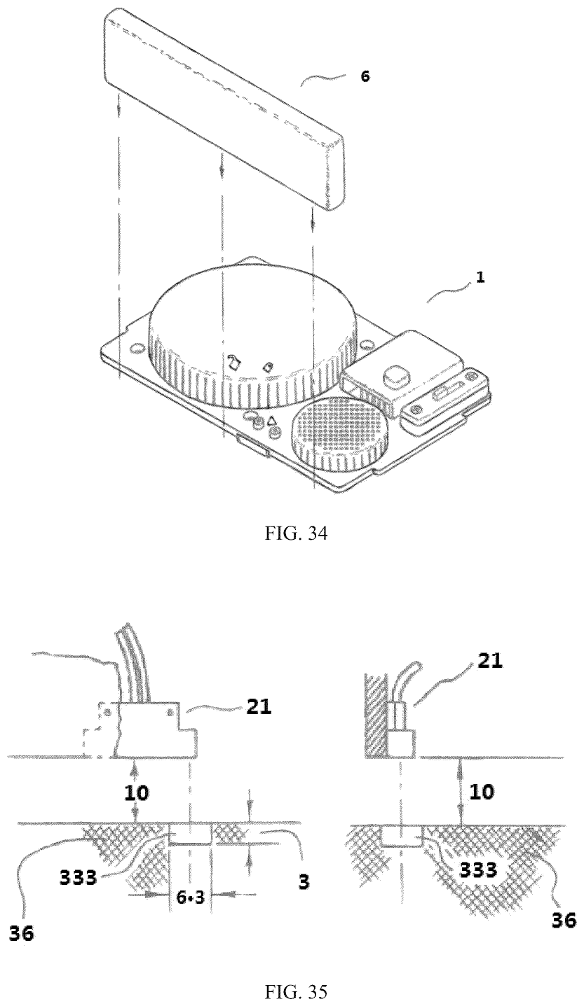

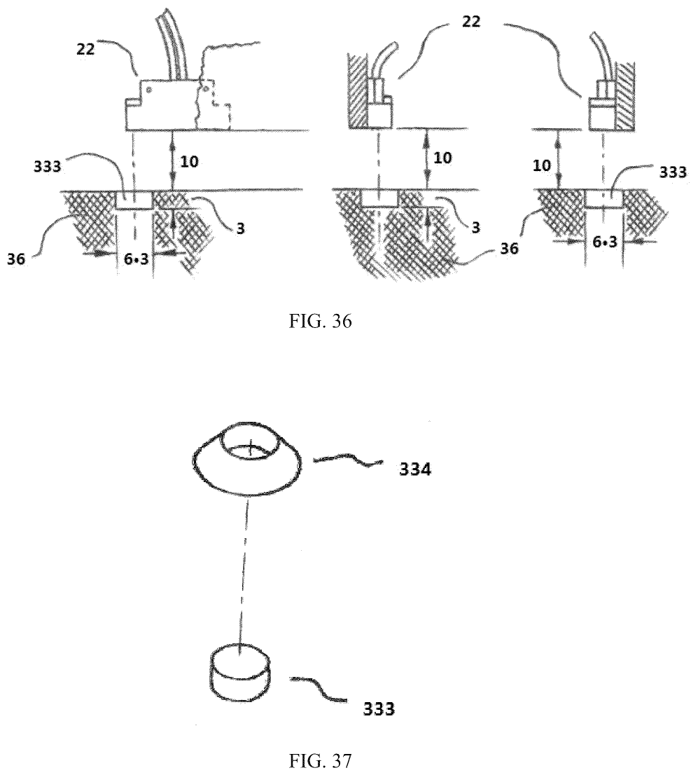

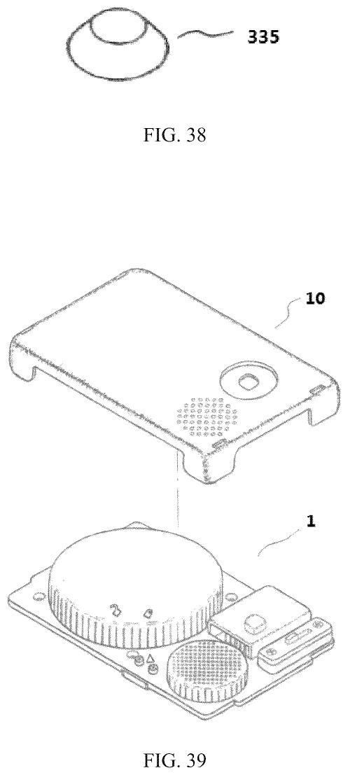

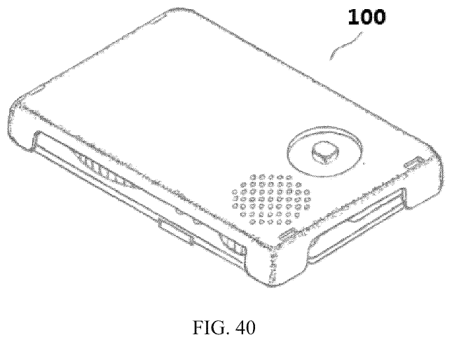

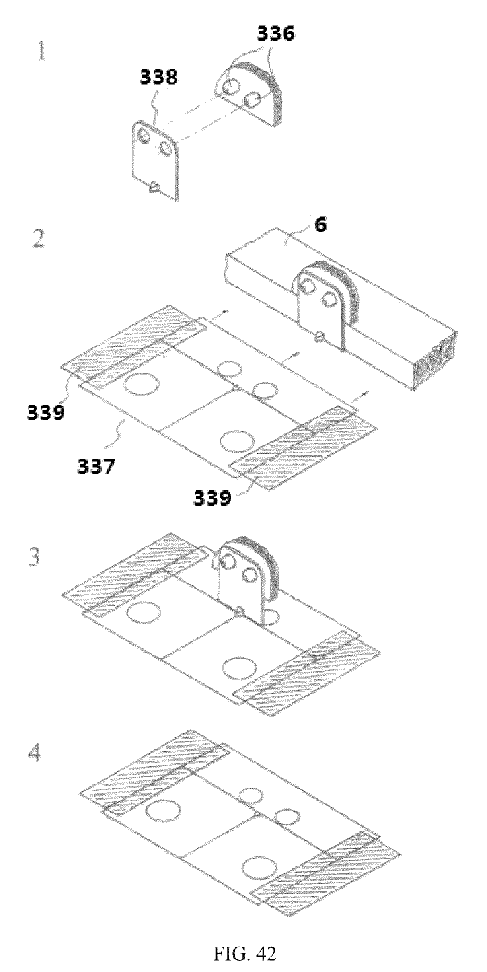

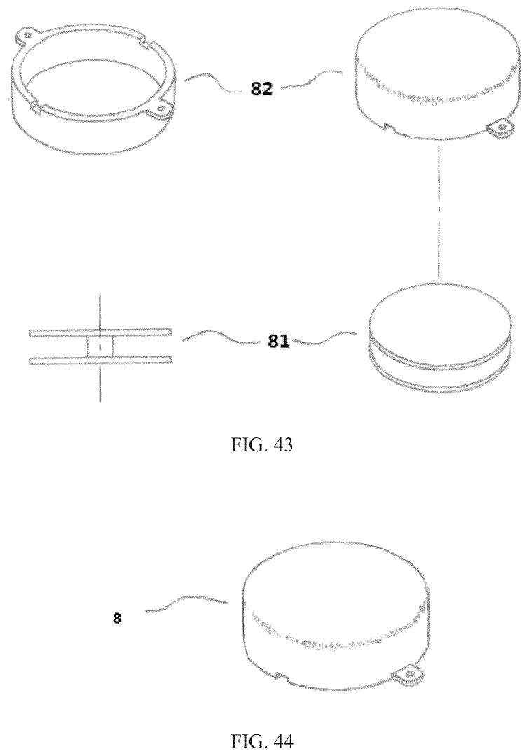

There is a 10 mm thick styrofoam piece provided for supporting the main-body during its installation of mounting on the bottom edge of the car door when the reed switch box is preferred to be fixed on the back bottom edge of the main-body (FIG. 34). Take the provided plate 338 (STEP 1 OF FIG. 42) and push it with its two holes inserted completely by the two short pillars 336 until fully contacting the main-body; take the provided card 337 and stick two pieces of adhesive tape 339 to two opposite sides of the card (STEP 2 OF FIG. 42); take the provided styrofoam piece with its middle part touching the back of the plate 338 and let them stand on the provided card 337 for mounting the main-body on the bottom edge of the car door; after fixing the main-body near the bottom edge of the car door, take two chopsticks or similar articles to move the card with the chopstick tips inside the two bigger holes of the card. Push the card to slide between the plate 338 and the cabin floor until the card stays in the position with the lines of the card right under the front edge of the plate and the plate's middle horn tip pointing the straight line between the two bigger holes (STEP 3 OF FIG. 42). Use finger(s) or the chopstick tip(s) to press the adhesive tape pieces on the car floor until they can hold that card quite firmly on the car cabin floor. Open the car door, press the adhesive tape again to the car floor to ensure it will not separate off. The car cabin floor under either of the two smaller holes of the card is the correct location for mounting the strong permanent magnet 333. Choose either of them to mount the permanent magnet which can be embedded in the car cabin floor. Use a piercer or a sharp cutter to engrave a circle mark on the car cabin floor shown by either of the two smaller holes. It can also be fixed on the car cabin floor with fast-setting epoxy adhesive or other efficient adhesive and having the permanent magnet protector 334 holding it (FIG. 38).

Excessive length of the wires 1122 & 1123 are provided for mounting in various vehicles. The user can cut away excessive length of the wires about the middle part and then connect the two wire ends of the respective wires by solder separately. There is no need to connect them to their original cut ends; the connected parts must be wrapped by insulation tape and better concealed under the main-body. The user can also choose to wind the excessive length of the wires 1122 or 1123 in the provided respective wires-reel 81 which is to be concealed in the respective wires-reel cover 82. There are two symmetrical lugs and recesses respectively at the bottom edge of the wires-reel cover. Each lug has a hole in the middle part for screw-fixing the wires-reel cover on the car door. The two recesses allow in and out of the wires 1122 or 1123.

The two wires 1124 are solder-connected to the loudspeaker 121 of the sound generator box 12 (FIGS. 15 & 16) which comprises a loudspeaker, a sound generator box frame 122 and a sound generator box screw-cap 123; there is a hole in the box frame 122 base to let the connection wires to pass through; the rim of the loudspeaker touches the box internal wall; it is sealed along the box internal wall by instant adhesive; the space of the hole where the wires pass through is sealed with industry adhesive, water cannot enter the back side of the loudspeaker from its front side and the cable hole. There are numerous pores through the box screw-cap 123 for sound transmission.

The fifth wires 1125 are connected to the third reed switch box of the sound stopping button assemblage 16 (FIGS. 18 & 19) which is a platform on the upper part of the main-body. It comprises an upper part having a square opening with two pairs of different arc corners for matching the vertical surface of the sound stopping button 161, a reed switch box 21 embedded partly in the recess of that upper part, the sound stopping button with a small, strong permanent magnet 162, a spring 163 for returning the sound stopping button to its top position after being pressed, and a barrier support plate 164 for holding the assemblage and supporting the sound stopping button from being pressed; the barrier support plate is fixed to the main-body back by four clips about the four corners respectively. The barrier can prevent the finger or other objects from pushing the spring off; it is also a ventilative design for letting the entered water vaporize easily; the accumulated dust can be flushed away by water jet. When the sound stopping button is fully pressed, the reed switch box 21 will leave the magnetic force position of the small, strong permanent magnet 162 embedded inside the sound stopping button, and thus will switch off the reed switch box to stop the reminding sound. After pressing the sound stopping button for stopping the call, it needs no another button pressing to restore the reminding function because the reminder will not be switched off by pressing the sound stopping button 161.

The following is the working principle of the present invention (market product). When the passenger pulls the door opening handle from inside the car cabin to open the door, the efficient magnetic field of the permanent magnetic set 33 from the door opening handle will sweep the scale line part at the small, strong permanent magnet of the permanent magnet reed switch box 22 which is kept switching on by a weaker magnetic force of the small, strong permanent magnet 162 from an opposite magnetic pole. The efficient magnetic field of the permanent magnet set 33 will neutralize the magnetic force of the permanent magnet 162 and cause a flash switching off of the reed switch; the circuit will then be activated; but the car door is not yet open to switch off the reed switch box 21 which keeps switching on by the strong permanent magnet 333 on the car cabin floor; when the car door is pushed open more than two cm, the reed switch box 21 near the car door edge will resume its switching off state making the reminding sound release; the returning back of the door opening handle to its original position will cause the reed switch of the permanent magnet reed switch box another switching off flash; this does not affect or even ensures the activation of the reminding sound. Closing the car door can stop the reminding sound automatically because the effective magnetic force of the strong permanent magnet 333 switches on again the reed switch box 21 near the car door edge.

If the small, strong permanent magnet 162 attaching to the reed switch box close to the scale line has its magnetic pole the same as that of the strong permanent magnet 332 facing downwards, and the permanent magnet reed switch box 22 is moved to mount with the scale line of its other end situated within 10 mm right under the permanent magnet set 33 locus (sideward deviation within 3 mm is valid), the reminding sound can also be activated when the car door opening handle is pulled to open the door from inside the car cabin.

Supplementary function 1: Pressing the sound stopping button 161 fully down can stop the reminding sound at once. After stopping the call, it needs no another button-pressing to restore the call function because that pressing cannot switch off the reminder. The next call will start from the beginning.

Supplementary function 2: If the passenger inside the cabin wants to avoid the call for that time, that button should be pressed down with one finger and held with the cooperation of another one or two fingers until the door's opening displacement made by the other hand is at least 2 or 3 cm and the door-opening handle returned to its original position.

### SECOND EMBODIMENT

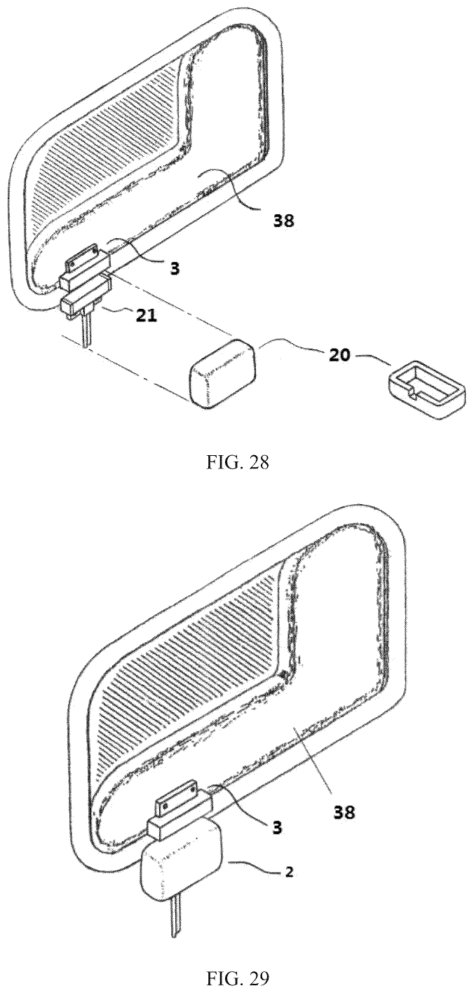

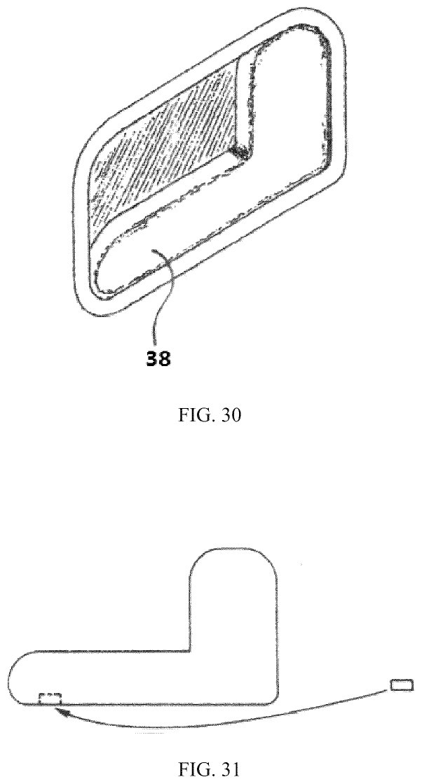

This embodiment adopts basically the same circuitry as that of the first one and shown in FIG. 46. The difference is that the permanent magnet set 33 is replaced by a permanent magnetic rod box 3 mounted on the front part of the door opening handle inside the car cabin (FIGS. 28 & 29). A reed switch box 21 replacing the permanent magnet reed switch box 22 is mounted on the car door exactly facing the permanent magnetic rod box 3 above within 8 mm. Another safety cover 20 can be mounted to shelter the permanent magnetic rod box 3. The reed switch box 21 is connected by the wires 1122 to the watertight circuit board set 112A which is also wires 1123 connected to another reed switch box 21 mounted near the car door edge exactly the same as that of the first embodiment. Other wires of 1121, 1124, 1125 & 1126 are also connected the same way as that of the first embodiment.

The working principle and functions are similar to that of the first embodiment. For using the supplementary function 2, the sound stopping button 161 should be pressed down fully with one finger and held with the cooperation of another one or two fingers until the door's opening displacement made by the other hand is at least 2 to 3 cm and there is no need to wait for the door-opening handle returned to its original position.

### THIRD EMBODIMENT

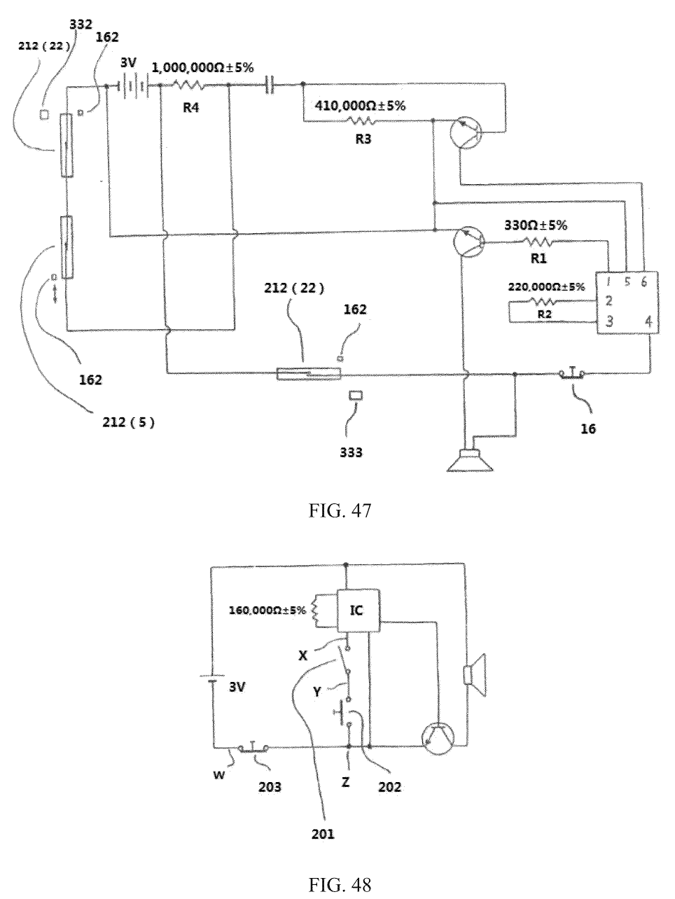

Although this embodiment uses the basic circuitry of the first or second embodiment, there is a little change in the circuitry's connection. The mounting part of the reed switching at the car door opening handle is entirely similar to that of the first embodiment. Its change is to connect a permanent magnet reed switch box 22 in series with the reed switch box of the sound stopping button assemblage 16 (FIG. 47) and mount near the car door edge to cooperate with the strong permanent magnet 333 fixed at the car cabin floor or door frame; the strong permanent magnet 333 has its effective magnetic force neutralizing that of the opposite magnetic pole of the small, strong permanent magnet 162 of the permanent magnet reed switch box 22 mounted near the car door edge within the closest perpendicular distance of 10 mm from the strong permanent magnet 333 (deviation within 3 mm is valid) which is provided with a scale mark at one of its end faces for showing its polarity (north or south pole).

When the car door opening handle from inside the cabin is pulled for opening the door, the effective magnetic field of the permanent magnet set 33 passes the relevant permanent magnet reed switch box 22 twice; the first passing of the car door opening handle cannot activate the reminder because the car door is still not opened making a circuit breaking by the car door edge switch. The second or return passing of the car door opening handle activates the reminder call because the door is opened wide enough for the magnetic force of the small, strong permanent magnet 162 of the permanent magnet reed switch box near the car door edge to connect its own reed switch inside. This embodiment is better than the first and the second embodiment in energy saving because the activation is switched off as the car door is closed. It is different from the case of the first and the second embodiment where the circuitry is still in activation state when the door is closed until the end of the call.

Other wires of 1121, 1124, 1125 & 1126 are connected exactly the same way as that of the former two embodiments.

The working principle and functions are similar to that of the first embodiment.

### Equipping Future Cars With This Invention Device Will Be Low Cost, Good Looking And Durable

If future cars are equipped with this invention device, it will be completely hidden inside the car door except two switches. One button press switch can be located near the door opening handle inside the car cabin for convenient using the sound stopping function. The other sideward push switch is for switching off the reminder. Its power source can come from a transformer connected to the car battery. A flash light can also be added during the reminder call similar to that of some cars'theft prevention alarm.

This function is useful to hearing impaired and/or partially deaf people. It is waterproof and can stand the most extreme weather temperature. It will never ignite any probably existing inflammable gas in its surroundings.

### FOURTH EMBODIMENT

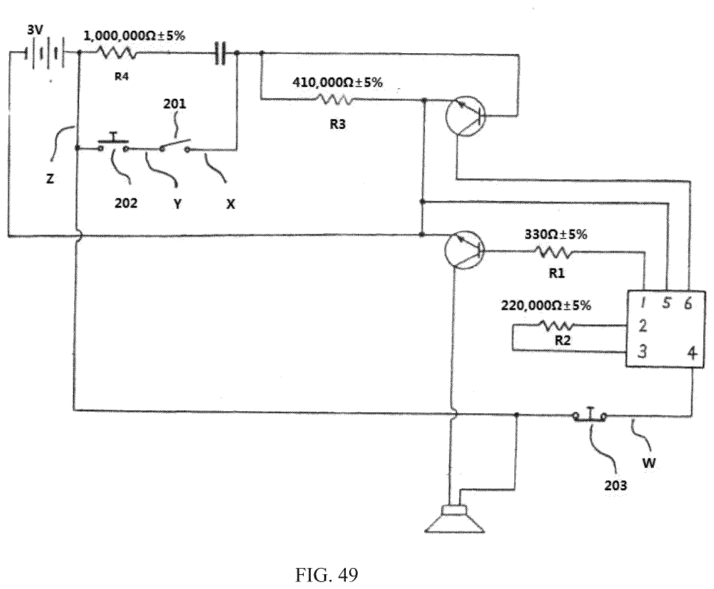

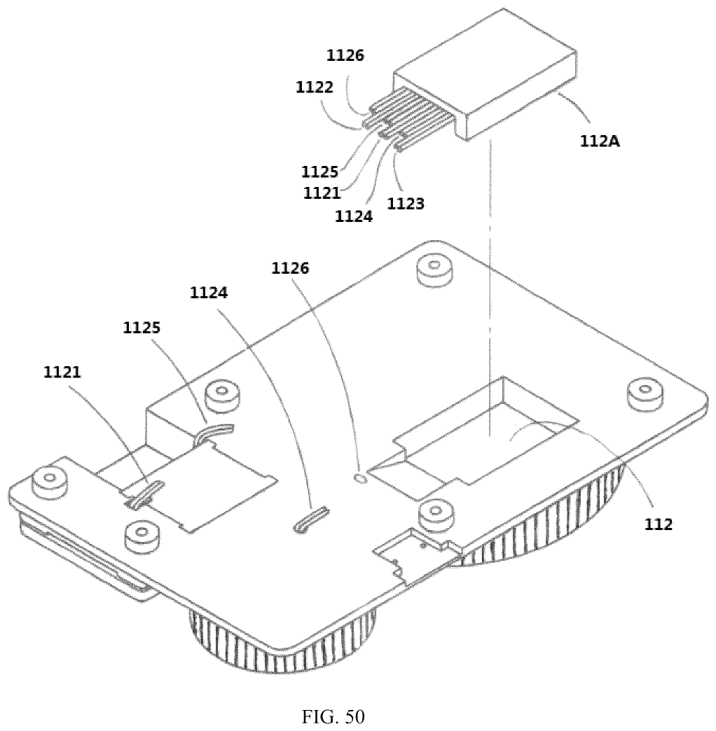

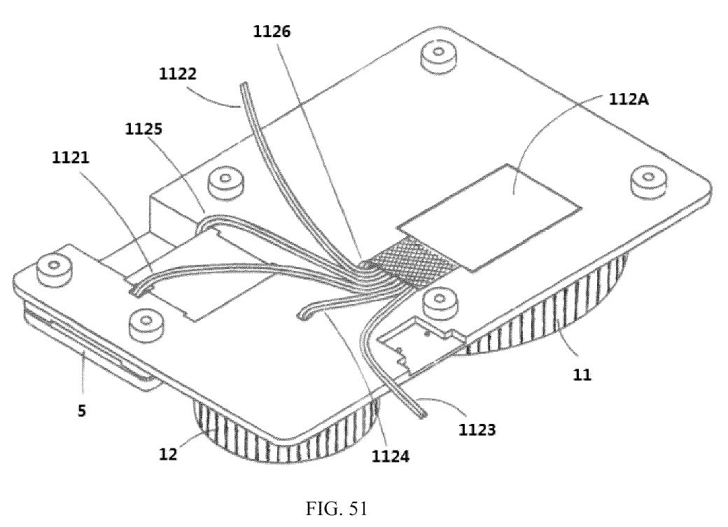

Many taxis are equipped with mechanism for the driver to open and close the door by pressing respective buttons. If the present invention is employed on such taxis, an extra device operated by the driver is needed. The circuit (FIG. 48) is modified from a domestic door bell music box circuit. But their switching connection is different. The circuit can also be the basic circuit of the previous embodiments (FIG. 49) which is more stable and durable.

The circuit of the device is switched on by the switch 201 as the taximeter starts. When the taxi arrives the destination, the passenger pays the fare and the driver switches to open the door; as that switch is connected to the push-to-make switch 202 and the circuit is still switched on though the taximeter stops running, so the reminder call is activated by the switching open of the door. After the passenger's getting off, the driver switches to close the door and switches simultaneously a push-to-break switch 203 which stops the call. The taximeter is then returned to the unhired position and the circuit 201 is simultaneously switched off.

Besides the previous embodiments of applying reed switches for merits of waterproof and avoidance of igniting any inflammable gas, there is another device avoidable of igniting any inflammable gas but perhaps lower in cost and not absolutely waterproof. As the device is installed on the upper part inside the taxi, the waterproof requirement is not so important. The push-to-make switch 202 can be sheltered in the base center of a screw-capped box 2021 (FIG. 33). There is a shaft 2024 extending through the cap center bearing tube 2025 to the button switch 2026 of the push-to-make switch. The shaft is fixed by a ring 2027. The ring 2027 and the button 2026 holds the shaft in-between the screw-cap 2023. When the box is screwed tight, pressing the button 2026 makes the push-to-make switch being pressed. The minute spark produced by switching that switch will never ignite any probably existing inflammable gas in its surroundings.

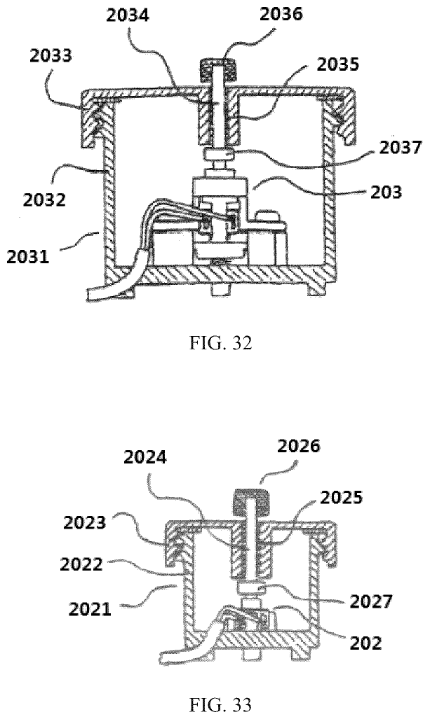

Similarly, the push-to-break switch 203 is sheltered in a bigger screw-capped box 2031 (FIG. 32). As the construction of both boxes is similar, so switching that push-to-break switch also will never ignite the inflammable gas surrounding it. The main body of this installation is a sound box with the circuit (FIG. 48/FIG. 49) inside. The power comes from the taxi battery. It should be mounted in a safe place in the taxi cabin and must provide clear reminder call. There are two double-wired cables passing through this sound box out to connect to the two screw-capped boxes with the push-to-make switch 202 and push-to-break switch 203 respectively. The first cable is connected to the X part and Z part of the circuit and comes out to connect to the push-to-make switch 202. The two switches are connected in series. The ordinary switch is switched on to connect the X part and Y part as the driver starts the taximeter. The push-to-make switch, sheltered in a smaller, screw-capped box is connected to the Y part and Z part of the cable. It is connected to the driver's door opening switch so that the switching open of the car door for the passenger's getting off will activate the sound box simultaneously. The second cable is connected to the W part and Z part of the circuit and comes out to connect to a push-to-break switch sheltered in a bigger screw-capped box. Its button switch is connected to the taxi's door closing switch so that switching close of the car door will break the circuit and will stop the call. After the passenger's getting off, the taximeter is then returned to the unhired position and the circuit 201 is switched off.

The foregoing embodiments are not intended to limit the protection scope of the technical solutions thereof, and any modifications, equivalent substitution and improvement made without departing from the spirit and principle of the foregoing embodiments shall all fall within the protection scope of the technical solutions provided hereinbefore.

1. A hand carry item(s) reminder for vehicle passenger comprises a main-body (1) connected with a first and a second reed switch boxes (21, 22) a permanent magnet set (33) or a permanent magnetic rod box (3), and a strong permanent magnet (333); the main-body comprises a battery box (11), a loud speaker (121) in a sound generator box (12), a main switch assemblage (5) and a sound stopping button assemblage (16) for stopping the reminder call but not switching off the reminder; the main-body (1) is arranged on the door inside the automobile and the permanent magnet set (33) is mounted on the back side or the permanent magnet rod box (3) is mounted on the front side of a door opening handle (38) and cooperate with the first reed switch box arranged below the door opening handle inside the car cabin such that a reminding sound is generated when the door opening handle from inside the car is pulled for opening the door, and the strong permanent magnet is arranged along the edge of a door frame or on the cabin floor (36) of the automobile and cooperate with the second reed switch box arranged on the door near the edge of the door frame or on the bottom edge of the back of the main-body so that the loudspeaker is switched off when the door is closed.

2. The hand carry item(s) reminder according to claim 1, wherein the permanent magnet set comprises a strong permanent magnet (332) and a permanent magnet carrier (331) with a scale line from top to bottom on the middle part of its slant side; the permanent magnetic rod box (3) comprises a permanent magnetic rod (32), a permanent magnetic rod box shell (31) and a safety cover (20) when mounted outside the car door opening handle; the first reed switch box is a permanent magnet reed switch box (22) in the First and the Third Embodiment;
the permanent magnet reed switch box comprises a reed switch (212) in a reed switch box with a compartment at one side of it to hold a small, strong permanent magnet (162), the permanent magnet reed switch box is kept switching on by the small, strong permanent magnet normally; it forms a magnetic push-to-break switch; there is a scale line marked 1 mm from either box end for visual indication guide of mounting it relating to the color scale line of the permanent magnet set above; the second reed switch box is merely a reed switch box (21) in the First and the Second Embodiment, it comprises a reed switch and a box body with a scale line 1 mm from either box end; the best position of fixing the permanent magnet (333) on the cabin floor or the door frame is to make its center within 10 mm at the closest perpendicular distance from the middle part of one of the scale line of the second reed switch box, deviation within 3 mm is valid.

3. The hand carry item(s) reminder according to claim 2 has two wires-connected reed switch boxes outside the main-body, the first reed switch box is a permanent magnet reed switch box and the second reed switch box is merely a reed switch box, or the first reed switch box and the second reed switch box both are reed switch boxes, or the first reed switch box and the second reed switch box both are permanent magnet reed switch boxes. the second reed switch box can be mounted on the back bottom edge of the main-body.

4. The hand carry item(s) reminder according to claim 1 has a platform on its upper part to form the sound stopping button assemblage (16); the platform has a square opening with two pairs of different arc corners for matching the vertical surface of the sound stopping button (161), there is a recess for embedding a portion of the third reed switch box inside the upper part of the platform; the sound stopping button has a small, strong permanent magnet (162) embedded in one side, there is also a spring (163) for returning the sound stopping button to its top position after being depressed fully and a barrier support plate (164) for fixing the assemblage; the barrier support plate is fixed to the main-body back by four clips about the four corners respectively; the barrier can prevent the finger or other objects from pushing the spring off; it is also a ventilative design for letting the entered water vaporize easily; the accumulated dust can be flushed away by water jet; the small, strong permanent magnet (162) inside the sound stopping button keeps the third reed switch box switching on the reminder circuit when the main switch is switched on; when the sound stopping button is depressed fully, the third reed switch box will leave the magnetic force position of being switched on by the small, strong permanent magnet making the reminding sound to stop at once; it needs no another button pressing to restore the reminder function; the next call will start from the beginning automatically.

5. The hand carry item(s) reminder according to claim 1 wherein the battery box (11) comprises a watertight circuit board shelter (112B) and a battery compartment (111) with solder-connected wires extending through a hole at the battery box base (113) to the main-body back to connect to the watertight circuit board set (112A) which also has wires connected to the main switch assemblage (5), the first and the second reed switch boxes (22) and/or (21), the sound stopping button (16) and the sound generator box (12); the external gaps between the wires and the slant entrance for them to the recess (112) for holding the circuit board set and the space between the wires and the hole at the battery box base are sealed with industry adhesive producing a watertight circuit board set (112A).

6. The hand carry item(s) reminder according to claim 1 wherein the main switch assemblage (5) comprises a fourth reed switch box embedded in a main switch base plate (51), a main switch cover 52, a push switch 53 and a spring wire with outward curves for match holding the inward curve brim of the push switch temporarily in either the ON/OFF position. The push switch body 531 has a recess in the middle bottom part for embedding the small, strong permanent magnet 162 which is fixed by instant adhesive. There is a slot track in the main switch cover 52 to form the track for the push switch. When the push switch is pushed to about the middle of the main switch cover 52 and held by the spring wire temporarily, the small, strong permanent magnet 162 will switch on the fourth reed switch box 21, namely, switch on the reminder. If the push switch is pushed to the other side of the track, the fourth reed switch box or the reminder will be switched off due to the absence of magnetic force of the small, strong permanent magnet 162.

7. The hand carry item(s) reminder according to claim 1 has a safety shield to cover the main-body for protecting it and the passenger and also for good-looking purpose; the safety shield has a common coin-sized, shallow recess above the sound stopping button area; the middle part of the recess has a hole with its perimeter fitting that of the sound stopping button which can be moved smoothly up and down; when the safety shield covers correctly on the main-body, the top of the sound stopping button levels the top surface of the safety shield; the corner parts of the safety shield have downward stretches carrying individual grippers to hold the bottom side of the main-body temporarily; holding to pull the lower side of the safety shield's either shorter side can open the safety shield; the four small rectangular holes are necessary when moulding the grippers, yet these holes can be covered by other assembling parts; the safety shield has enough pores for good sound transmission.

8. The hand carry item(s) reminder according to claim 1 comprises excessive length of wires connecting the first and the second reed switch box respectively; two wires-reels (81) are provided for winding the excessive length of the wires and sheltered by the respective wires-reel covers (82) which have lugs for being fixed on the car door by screws through the lug holes; the user can also cut away excessive length of the wires in the middle part and connect the wires respectively by solder, the connected parts must be wrapped by insulation tape.

9. The hand carry item(s) reminder according to claim 1 further comprises a switch control device in a taxi; the circuit is switched on by the switch 201 as the taximeter starts; when the taxi arrives the destination, the passenger pays the fare and the driver switches to open the door; as that switch is connected to the push-to-make switch 202 and the circuit is still switched on though the taximeter stops running, so the reminder call is released; after the passenger's getting off, the driver switches to close the door and triggers the push-to-break switch 203 which stops the call; the taximeter is then returned to the unhired position making the circuit switched off; as the switches are based on respective reed switch boxes operated by respective permanent magnets, it will not ignite any inflammable gas in its surroundings.

10. The hand carry item(s) reminder according to claim 9 wherein the push-to-break switch and/or the push-to-make switch are received in respective cylindrical containers (2021,2031) sealed with screwing caps (2023,2033), shafts (2024,2034) inserted through vertical bearings (2025,2035) into the screwing caps and positioned on the push-to-make switch and the push-to-break switch respectively, and the shafts are fixed to rings (2027,2037) with their lower ends and fixed to push buttons (2026,2036) with their upper ends, and the rings and the push buttons retain the shafts in the vertical bearings of the screwing caps respectively in a such a manner that the shafts are enabled to move up and down over a small range of distance; as the switches are completely closed in respective containers, it will not ignite any inflammable gas in its surroundings.
